(19) United States
(12) Patent Application Publication
(10) Pub. No.: US 2017/0005695 A1
(43) Pub. Date: Jan. 5, 2017

(54) PARTLY TUNABLE FILTER AND RADIO UNIT USING THE SAME

(71) Applicant: TELEFONAKTIEBOLAGET LM ERICSSON (PUBL), Stockholm (SE)

(72) Inventors: Jichang Liao, Beijing (CN); Xiaoliang Du, Beijing (CN); Jiangyan Peng, Beijing (CN)

(21) Appl. No.: 15/038,875

(22) PCT Filed: Dec. 4, 2013
(86) PCT No.: PCT/CN2013/088510

§ 371 Date: May 24, 2016

(51) Int. Cl. H04B 1/525; H04L 5/14

(52) U.S. Cl. CPC H04B 1/525; H04L 5/14

(57) ABSTRACT

A filter comprises a first tunable portion connected to a transmitting module, a second tunable portion connected to a receiving module, and a fixed portion connected to an antenna unit. The first tunable portion is works in a first frequency range different from a first pass band in which the second tunable portion is controlled to work when the radio frequency signal is received via the antenna unit, such that the received radio frequency signal is rejected by the first tunable portion to the transmitting module. The second tunable portion works in a second frequency range different from a second pass band in which the first tunable portion is controlled to work when the radio frequency signal from the transmitting module is to be transmitted via the antenna unit, such that the radio frequency signal to be transmitted is rejected by the second tunable portion to the receiving module.

### TECHNICAL FIELD

Embodiments of the invention generally relate to wireless communication technologies and more specifically, to a partly tunable filter and a radio unit for use in a time division duplex (TDD) communication system or a Frequency Division Duplex (FDD)-TDD multimode communication system.

### BACKGROUND

In the current communication systems, a base station may be divided into three parts: a base band unit (BBU), a remote radio unit (RRU) with optical fiber connecting the BBU to the RRU and an antenna unit. A radio unit may convert a digital base band signal received from a BBU to an analog radio frequency (RF) signal, then amplify and filter the RF signal and then transmit the amplified and filtered RF signal via the antenna unit or receive an analog RF signal via the antenna unit, then filter and amplify the RF signal and then convert the filtered and amplified RF signal to a digital base band signal.

In wireless communications, uplink refers to transmissions from terminals to base stations. Downlink refers to transmissions from base stations to terminals. There are two types of duplexing for uplink and downlink: FDD and TDD. In a FDD system, uplink and downlink use different frequencies, while in a TDD system, uplink and downlink use a same frequency.

In a typical time division communication system, e.g. a TDD communication system, the radio unit of a base station typically transmits and receives RF signals via the antenna unit in different time slots. When the radio unit works in a transmitting (Tx) slot, there may be a risk for its receiver front end to withstand a high power signal reflected from an antenna port of the antenna unit due to mismatch of the antenna port. The reflected energy is usually proportional to the degree of the mismatch. The more the antenna port is mismatched, the more energy may be reflected from the antenna port to the receiver front end. Especially, when the antenna port is open, all transmitting energy may be reflected to the receiver front end, which is vital and may cause the receiver front end, particularly a low noise amplifier (LNA) included therein, to be broken. Therefore, protection for the receiver front end is critical in a TDD communication system.

FIG. 1 illustrates an existing solution to the above problem. As illustrated, a high power Single-Pole Double-Throw (SPDT) switch is added before the LNA to protect it from damaging by the high reflected energy. With this configuration, when a downlink signal is to be transmitted in a Tx slot, the SPDT switch is switched to a high power 50 ohm load, which can absorb the reflected energy from the antenna port if there is any, as shown in FIG. 1A. By contrast, when an uplink signal is received in a receiving (Rx) slot, the SPDT switch is switched to the LNA, as shown in FIG. 1B. During the switching of the high power SPDT between the 50 ohm load and the LNA, an exact timing control based on the TDD timing template is required.

However, there are some disadvantages with the existing solution. For example, since insertion loss (IL) of a high power TR (Tx-Rx) switch, such as the SPDT switch, is generally above 0.5 dB and the IL of a circulator is typically 0.3 dB, the total IL except for the IL introduced by a RF filter on the receiving path is up to 0.8 dB, which results in receiver's noise figure (NF) increasing at least 0.8 dB. Additionally, the dimension of a TR switch is large, for example, about 45 mm×5 mm for a 40 W system, which may result in a bulky radio unit. Another disadvantage is that there may exist several mismatch sources for the receiver front end, for example, output impedance of a power amplifier in the transmitter when it is not operating, the circulator, and the TR switch etc. Furthermore, return loss (RL) of the TR switch is different between Tx and Rx slots, and thus it is hard to balance the RL at the antenna port.

Another disadvantage of the existing solution is that the Tx-Rx board currently used in a TDD system is not compatible with that in a FDD system, which may result in an increase of complexity and cost, when the TDD system transitions to or is upgraded to a TDD-FDD multimode communication system.

Another related solution is described in a European patent application No. EP2073394 A1. This solution may realize a FDD-TDD filter by directly using two separate tunable filters, however it has such disadvantages as higher complexity, cost, power consumption and large dimension. Yet another related solution as described in U.S. Pat. No. 6,185,434 also directly combines two separate filters together. Thus, the combined filter will also have the disadvantages of each individual filter as mentioned above.

### SUMMARY

Various embodiments of the invention aim at addressing at least part of the above problems and disadvantages. Other features and advantages of embodiments of the invention will also be understood from the following description of specific embodiments when read in conjunction with the accompanying drawings, which illustrate, by way of example, the principles of embodiments of the invention.

Various aspects of embodiments of the invention are set forth in the appended claims and summarized in this section. It shall be understood that the protection scope of the invention is only limited by the appended claims.

In a first aspect of the invention, a radio unit for use in a time division duplex communication system is provided. The radio unit comprises a transmitting module; a receiving module; and a filter for filtering a RF signal to be transmitted or received via an antenna unit. The filter comprises a first tunable portion connected to the transmitting module, a second tunable portion connected to the receiving module, and a fixed portion connected to the antenna unit. Each of the first tunable portion and the second tunable portion is configured to connect to the antenna unit via the fixed portion. The first tunable portion is further configured to work in a first frequency range different from a first pass band in which the second tunable portion is controlled to work when the RF signal is received via the antenna unit, such that the received RF signal is rejected by the first tunable portion to the transmitting module. The second tunable portion is further configured to work in a second frequency range different from a second pass band in which the first tunable portion is controlled to work when the RF signal from the transmitting module is to be transmitted via the antenna unit, such that the RF signal to be transmitted is rejected by the second tunable portion to the receiving module.

In some embodiments, the filter may comprise a plurality of cavities and each of the first tunable portion, the second tunable portion and the fixed portion may comprise at least one cavity.

In some embodiments, the first tunable portion and the second tunable portion may be tuned separately by a first tuning circuit and a second tuning circuit that are triggered by a control signal.

In some embodiments, each of the first and second tuning circuits may comprise at least one PIN diode.

In some embodiments, the transmitting module may further comprise an isolator capable of absorbing energy reflected from the antenna unit when the RF signal is transmitted.

In some embodiments, the isolator may comprise a circulator.

In some embodiments, the first frequency range may be non-overlapping with the first pass band; and/or the second frequency range may be non-overlapping with the second pass band.

In a second aspect of the invention, a base station for use in a time division duplex communication system is provided. The base station comprises the radio unit according to the second aspect of the invention.

In a third aspect of the invention, a partly tunable filter for filtering a RF signal is provided. The partly tunable filter comprises three ports and also comprises a first tunable portion coupled to a first port, a second tunable portion coupled to a second port, and a fixed portion coupled to a third port. Each of the first tunable portion and the second tunable portion is configured to couple to the third port via the fixed portion. The first tunable portion is further configured to work in a first frequency range different from a first pass band in which the second tunable portion is controlled to work when the RF signal is to be transmitted from the third port to the second port, such that the RF signal is rejected by the first tunable portion to the first port. The second tunable portion is further configured to work in a second frequency range different from a second pass band in which the first tunable portion is controlled to work when the RF signal is to be transmitted from the first port to the third port, such that the RF signal is rejected by the second tunable portion to the second port.

In a fourth aspect of the invention, an apparatus for use in a time division duplex communication system is provided. The apparatus comprises the partly tunable filter according to the third aspect of the invention.

In a fifth aspect of the invention, a radio unit for use in a multimode communication system is provided. The radio unit comprises a transmitting module, a receiving module and a filter for filtering RF signals to be transmitted or received via an antenna unit. The RF signals comprise a first RF signal of a first frequency, a second RF signal of the first frequency, a third RF signal of a second frequency and a fourth RF signal of a third frequency. The filter comprises a first filtering part and a second filtering part. The first filtering part comprises a first tunable portion connected to the transmitting module, a second tunable portion connected to the receiving module, and a first fixed portion connected to the antenna unit. Each of the first tunable portion and the second tunable portion is configured to connect to the antenna unit via the first fixed portion. The second filtering part comprises a second fixed portion connected to the transmitting module and the antenna unit, and configured to work in a transmitting band for the third RF signal; and a third fixed portion connected to the receiving module and the antenna unit, and configured to work in a receiving band for the fourth RF signal. The first tunable portion is further configured to work in a first frequency range different from the transmitting band, such that the third RF signal from the transmitting module is rejected by the first tunable portion, and the first frequency range is further different from a first pass band for the second RF signal in which the second tunable portion is controlled to work when the second RF signal is received via the antenna unit, such that the received second RF signal is rejected by the first tunable portion to the transmitting module. The second tunable portion is further configured to work in a second frequency range different from the receiving band, such that the fourth RF signal received via the antenna unit is rejected by the second tunable portion, and the second frequency range is further different from a second pass band for the first RF signal in which the first tunable portion is controlled to work when the first RF signal from the transmitting module is to be transmitted via the antenna unit, such that the first RF signal to be transmitted is rejected by the second tunable portion to the receiving module.

In some embodiments, the transmitting module may comprise a multimode transmitter and the second pass band is non-overlapping with the transmitting band.

In some embodiments, the transmitting module may further comprise an isolator capable of absorbing energy reflected from the antenna unit when the first or third RF signal is transmitted.

In some embodiments, the receiving module may comprise a multimode receiver and the first pass band is non-overlapping with the receiving band.

In some embodiments, the filter may comprise a plurality of cavities; and each of the first tunable portion, the second tunable portion and the first, second and third fixed portions may comprise at least one cavity.

In some embodiments, the first tunable portion and the second tunable portion may be separately tuned by a first tuning circuit and a second tuning circuit that are triggered by a control signal.

In some embodiments, each of the first and second tuning circuits may comprise at least one PIN diode.

In some embodiments, the first frequency range may be non-overlapping with the first pass band and the transmitting band; and/or the second frequency range may be non-overlapping with the second pass band and the receiving band.

In a sixth aspect of the invention, a base station for use in a multimode communication system is provided. The base station comprises the radio unit according to the fifth aspect of the invention.

In a seventh aspect of the invention, a partly tunable filter for filtering RF signals is provided. The partly tunable filter is configured for filtering RF signals. The RF signals comprise a first RF signal of a first frequency, a second RF signal of the first frequency, a third RF signal of a second frequency and a fourth RF signal of a third frequency. The partly tunable filter comprises five ports and a first filtering part and a second filtering part. The first filtering part comprises a first tunable portion coupled to a first port, a second tunable portion coupled to a second port, and a first fixed portion coupled to a third port. Each of the first tunable portion and the second tunable portion is configured to couple to the third port via the first fixed portion. The second filtering part comprises a second fixed portion coupled to a fourth port and the third port and configured to work in a transmitting band for the third RF signal, and a third fixed portion coupled to a fifth port and the third port and configured to work in a receiving band for the fourth RF signal. The first tunable portion is configured to work in a first frequency range different from the transmitting band, such that the third RF signal from the fourth port is rejected by the first tunable portion. The first frequency range is further different from a first pass band for the second RF signal in which the second tunable portion is controlled to work when the second RF signal is to be transmitted from the third port to the second port, such that the second RF signal is rejected by the first tunable portion to the first port. The second tunable portion is configured to work in a second frequency range different from the receiving band, such that the fourth RF signal from the third port is rejected by the second tunable portion. The second frequency range is further different from a second pass band for the first RF signal in which the first tunable portion is controlled to work when the first RF signal is to be transmitted from the first port to the third port, such that the first RF signal is rejected by the second tunable portion to the second port.

In an eighth aspect of the invention, an apparatus for use in a multimode communication system is provided. The apparatus comprises the partly tunable filter according to the seventh aspect of the invention.

According to particular embodiments in relation to the partly tunable filter and the radio unit as described in this specification, the receiver front end in the radio unit of a base station can be effectively protected by the partly tunable filter, while keeping the insertion loss, system complexity, cost, power consumption and dimension as low as possible. In addition, based on the structure of the partly tunable filter designed for a TDD system, a real FDD-TDD multimode filter can be developed, which can not only provide an efficient protection for the receiver front end of a radio unit but also offer a significant reduction of the system complexity, cost, power consumption and dimension.

Other features and advantages of the embodiments of the present invention will become apparent from the following description of specific embodiments when read in conjunction with the accompanying drawings, which illustrate, by way of example, the principles of embodiments of the present invention.

### BRIEF DESCRIPTION OF THE DRAWINGS

The above and other aspects, features, and benefits of various embodiments of the invention will become more fully apparent, by way of example, from the following detailed description and the accompanying drawings, in which like reference numerals refer to the same or similar elements:

FIGS. 1A-1B illustrate an existing solution for protection of a receiver front end in a radio unit.

FIG. 2 illustrates a simplified structure of a radio unit for use in a TDD communication system according to one embodiment of the invention.

FIG. 3A illustrates an equivalent circuit model of a general filter cavity and

FIGS. 3B-3D respectively illustrate different example methods for tuning a filter cavity.

FIG. 4A illustrates a schematic circuit diagram of a partly tunable filter for use in a TDD communication system according to one embodiment of the invention.

FIG. 4B shows a schematic circuit illustrating operation states of PIN diodes for tuning filter cavities as shown in FIG. 4A.

FIG. 5 illustrates an example implementation of the filter 230 of FIG. 2, which is implemented as a partly tunable cavity filter.

FIG. 6 illustrates a simplified structure of a radio unit for use in a FDD-TDD multimode communication system according to one embodiment of the invention.

FIGS. 7A-7B illustrate an example implementation of the filter 630 of FIG. 6, which is implemented as a partly tunable cavity filter.

FIG. 8 illustrates a partly tunable filter for use in a TDD dual band communication system.

### DETAILED DESCRIPTION

In the following description, numerous specific details are set forth. However, it shall be understood that embodiments of the invention may be practiced without these specific details. In other instances, well-known circuits, structures and techniques have not been shown in detail in order not to obscure the understanding of this description. It will be appreciated, however, by one skilled in the art that the invention may be practiced without such specific details. In other instances, control structures, gate level circuits, and control signal flows have not been shown in detail in order not to obscure the invention. Those of ordinary skills in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that, although the terms “first”, “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

In the following description and claims, the terms “coupled” and “connected,” along with their derivatives, may be used. It should be understood that these terms are not intended as synonyms for each other. “Coupled”, along with its derivatives, can be used to indicate that two or more elements within a same device, e.g. a filter, may or may not be in direct physical or electrical contact with each other. “Connected”, along with its derivatives, can be used to indicate that two or more devices are externally connected to each other. It shall be understood that when a device is referred to as being “connected” to another device, it can be directly connected to the other device or intervening devices may be present.

The terminology used herein is for the purpose of describing particular embodiments only and is not intended to be liming of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, the term “cavity” may be used. It should be understood that the term “cavity” used therein not only comprise a mechanical structure of a cavity but also comprise a resonator included in the cavity. Thus, for example, “tuning a cavity” indicates that the resonator in the cavity is tuned so as to shift a resonant frequency of the cavity. The term “tunable” may be used for describing a cavity or a portion. It should be understood that the term “tunable” used therein means that the cavity or the portion can be electrically tuned in response to a control signal, unless the context clearly indicates otherwise.

Reference is first made to FIG. 2, in which a simplified structure of a radio unit 200 for use in a TDD communication system according to one embodiment of the invention is illustrated.

The illustrated radio unit 200 comprises a transmitting module 210 which may be configured to generate a RF signal for transmission via an antenna unit 250, a receiving module 220 which may be configured to receive and process the RF signal received via the antenna unit 250, and a filter 230 which is configured for filtering the RF signal to be transmitted or received via the antenna unit 250 so as to filter out unwanted RF components included therein.

In this embodiment, the illustrated filter 230 is implemented as a partly tunable filter. The term “partly tunable” used herein means that some portions of the filter (e.g. a first and second tunable portions 231, 232 as described later) can be electrically tuned while at least one portion of the filter (e.g. a fixed portion 233 as described later) cannot be electrically tuned.

The illustrated filter 230 comprises a first tunable portion 231 that is connected to the transmitting module 210, a second tunable portion 232 that is connected to the receiving module 220, and a fixed portion 233 that is connected to the antenna unit 250.

Each of the first tunable portion 231 and the second tunable portion 232 are connected to the antenna unit 250 via the fixed portion 233. That is, the fixed portion 233 is shared by both uplink and downlink transmissions.

In such an embodiment, the fixed portion 233 of the filter 230 is configured, for example by mechanically adjusting, to always work in a pass band for the RF signal to be transmitted or received (which will be referred to as a fixed pass band hereafter) during both downlink and uplink transmissions.

The first tunable portion 231 is configured to work in a first frequency range different from a first pass band in which the second tunable portion 232 is controlled to work when a RF signal is received via the antenna unit 250, i.e. in a Rx slot, such that the received RF signal can be rejected by the first tunable portion 231 to the transmitting module 210. With such a configuration, most or all energy of the RF signal received via the antenna unit 250 can enter into the second tunable portion 232 and finally be received by the receiving module 220 for processing. This may reduce the insertion loss introduced by the filter 230 on the receiving path from the antenna unit 250 to the receiving module 220 as low as possible.

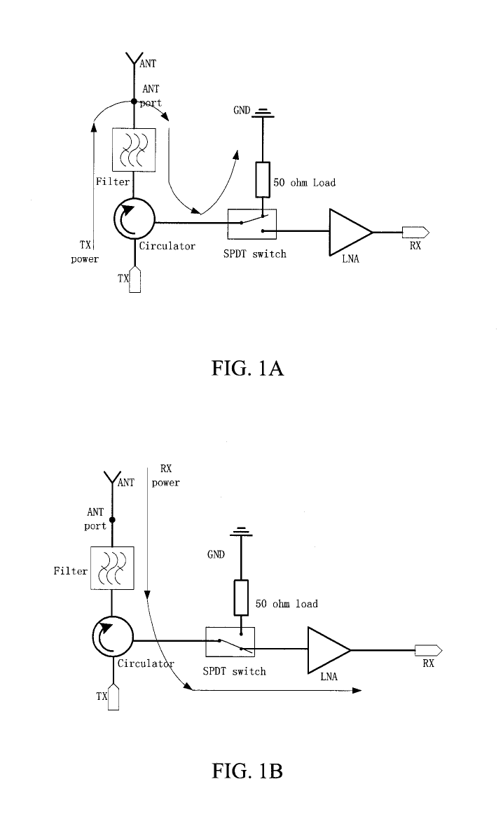

The second tunable portion 232 is configured to work in a second frequency range different from a second pass band in which the first tunable portion 231 is controlled to work when a RF signal is to be transmitted from the transmitting module 210, i.e. in a Tx slot, such that the RF signal to be transmitted is rejected by the second tunable portion 232 to the receiving module 220. With such a configuration, even though the antenna port of the antenna unit 250 mismatches or is open, the reflected energy from the antenna port will not enter into the receiving module 220 and has to get back to the transmitting module 210, by which the receiver front end in the receiving module 220 can be protected from damaging by the transient high reflected energy. In one embodiment, the transmitting module 210 may comprise an isolator 240 capable of absorbing the energy reflected from the antenna unit 250. In another embodiment, the isolator 240 may comprise a circulator, which may have three ports with one port being coupled to a matched load, e.g. a 50 ohm load as illustrated in FIG. 2. Compared with the existing solution as illustrated in FIG. 1, since the isolator 240 is interposed in the transmitting path from the transmitting module 210 to the antenna unit 250 as a part of the transmitting module 210, it will not affect the receiving path, thereby further reducing the total insertion loss on the receiving path.

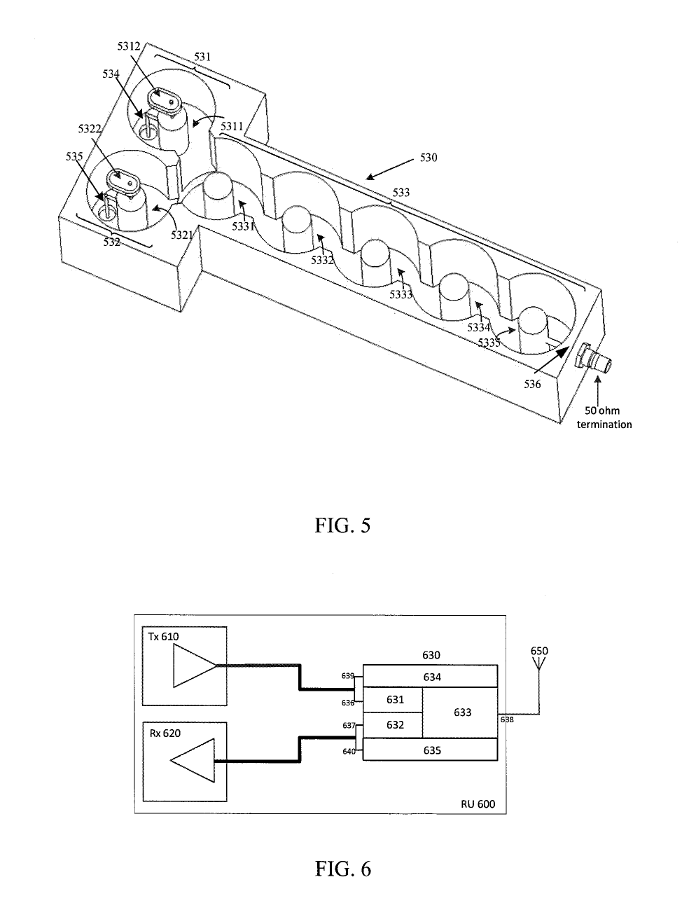

Specifically, the first tunable portion 231 of the filter 230 may be tuned by a first tuning circuit (e.g. 5312 as shown later in FIG. 5) to either work in the first frequency range when it is required to reject the received RF signal or work in the second pass band so as to pass the RF signal to be transmitted through. Similarly, the second tunable portion 232 of the filter 230 may be tuned by a second tuning circuit (e.g. 5322 as shown later in FIG. 5) to either work in the second frequency range when it is required to reject the RF signal reflected from the antenna port or work in the first pass band so as to pass the RF signal received via the antenna unit 250 through.

In one embodiment, the first tuning circuit and second tuning circuit may be embodied separately from or integrated into a control circuit (not shown) and may be triggered to operate by a control signal from the control circuit.

Generally, the aforesaid fixed pass band, the first pass band and the second pass band are configured to be within a same TDD band as specified by communication standards or protocols. They may have at least one overlapping part that covers the frequency of the RF signal to be transmitted or received. However, these three pass bands may not necessarily be identical. For example, the fixed pass band may be wider or narrower than the first pass band or the second pass band or vice versa.

For uplink transmissions, the first frequency range of the first tunable portion 231 may be partly overlapping with the first pass band of the second tunable portion 232, as long as the energy of the received signal that can pass through the first tunable portion 231 is sufficiently low so as not to distract much energy from the received signal and thus not to significantly affect the noise figure of the received RF signal at the receiving unit 220. For downlink transmissions, the second frequency range of the second tunable portion 232 may also be partly overlapping with the second pass band of the first tunable portion 231, as long as the energy of the transmitted signal that can pass through the second tunable portion 232 is sufficiently low so as not possible to damage the receiving unit 220.

Preferably, the first frequency range of the first tunable portion 231 may be non-overlapping with the first pass band of the second tunable portion 232. Alternatively or additionally, the second frequency range of the second tunable portion 232 may be non-overlapping with the second pass band of the first tunable portion 231. Further preferably, a gap between the first frequency range of the first tunable portion 231 and the first pass band of the second tunable portion 232 as well as the gap between the first frequency range of the second tunable portion 232 and the second pass band of the first tunable portion 231 may be configured to be as large as possible.

In one embodiment, the filter 230 may be implemented as a partly tunable cavity filter, although other types of filters, such as a LC filter, surface acoustic wave (SAW) filter, bulk acoustic wave (BAW) filter and waveguide filter are also possible. Advantages of cavity filters at least include high power handling ability, low insertion loss and a high Q factor, which enable cavity filters to be popularly used in high power communication equipments, such as in a base station.

In this embodiment, the filter 230 may comprise a plurality of cavities. For example, each of the first tunable portion 231 and the second tunable portion 232 of the filter 230 may comprise at least one tunable cavity, depending on isolation or rejection requirements. Each of the cavities comprised in the first or second tunable portion may be separately tuned by the first and second tuning circuits. The fixed portion 233 may also comprise at least one fixed cavity, typically 8-10 cavities, depending on performance requirements, e.g. a Q factor. Q factor characterizes a resonator's or cavity's bandwidth relative to its center frequency. Higher Q indicates a lower rate of energy loss relative to the stored energy of the resonator or cavity. Usually, a cavity of the higher Q factor will introduce the less insertion loss. More cavities may provide better out band rejection performance or higher isolation. For example, one cavity may provide 40 dB isolation performance while two cavities may provide 80 dB isolation performance.

In one embodiment, the number of cavities in the first tunable portion 231 may be less than that in the second tunable portion 232, for example because in a Tx slot, the second tunable portion 232 is required to provide pretty high isolation (e.g. >45 dB) so as to effectively protect the receiver front end, while in a Rx slot, the requirement on isolation of the first tunable portion 221 may be relaxed. However, use of more cavities means that more power is needed, and therefore the number of cavities in the first or second tunable portion of the filter 230 according to embodiments of the present invention may preferably be not more than 2.

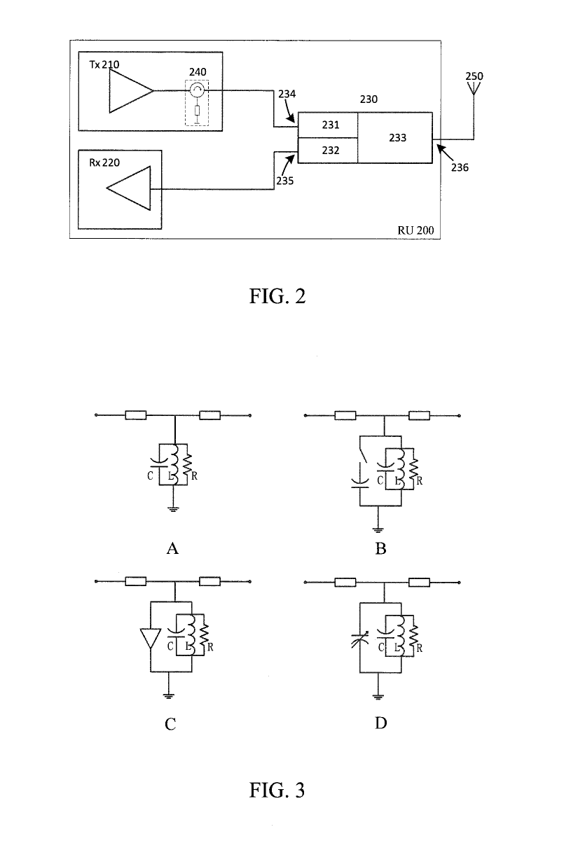

Hereafter, descriptions will be made with reference to FIGS. 3-5 to detail the structure and operations of the filter 230 when it is implemented as a partly tunable cavity filter.

The methods for tuning a filter cavity are firstly introduced with reference to FIG. 3.

FIG. 3A illustrates an equivalent circuit model of a general filter cavity and FIG. 3B-3D respectively illustrates different example methods for tuning a filter cavity. Generally, a PIN diode, varactor, microelectromechanical systems (MEMS) switch or combination of a switch and capacitor may be used to tune a filter cavity.

FIG. 3B illustrates employing a combination of a switch, such as the MEMS switch or PIN diode switch, and a capacitor to tune a filter cavity. FIG. 3C illustrates employing the PIN diode to tune a filter cavity. FIG. 3D illustrates employing the varactor to tune a filter cavity. The combination of a switch and a capacitor or the varactor is often used for filter tuning in a FDD system since it can offer precise controlling of the resonant frequency of a cavity so as to accommodate different frequencies of downlink and uplink RF signals in the FDD system.

However, in a TDD system, downlink and uplink transmissions use the same frequency, and it is not necessary to precisely tune a filter cavity(-ies) used for rejecting a RF signal (e.g. cavities in the second tunable portion 232 during downlink transmissions or cavities in the first tunable portion 231 during uplink transmissions) to work in a specific frequency range and meanwhile have a high Q factor. That is, for the partly tunable cavity filter according to embodiments of the present invention, the first tunable portion 231 is not required to have a high Q value in a Rx slot, as long as its work band can be shifted away from the pass band of the second tunable portion 232; and similarly, the second tunable portion 232 is not required to have a high Q value in a Tx slot, as long as its work band can be shifted away from the pass band of the first tunable portion 221. Therefore, more interests are focused on how to improve isolation performance of the two tunable portions by shifting resonant frequencies of the corresponding cavities included therein when they work for rejecting RF signals and also on how to improve Q factors of the two tunable portions when they work in respective pass bands (e.g. the first and second pass bands).

In this case, the PIN diode is preferably selected for tuning the resonant frequency of a filter cavity, since the PIN diode can offer faster switching performance compared to other elements and more importantly, the PIN diode has the least impact on the Q factor of a filter cavity tuned by it when it is in an OFF state.

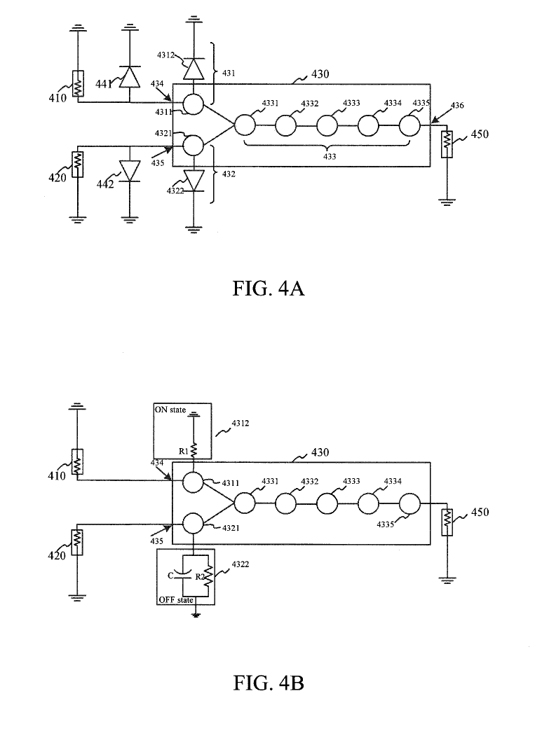

FIG. 4A illustrates a schematic circuit diagram of a partly tunable filter 430 with PIN diodes as tuning circuits according to one embodiment of the invention. In this embodiment, the illustrated partly tunable filter 430 comprises three ports 434˜436, a first tunable portion 431 that includes a cavity 4311 which may be tuned by a PIN diode 4312 and is coupled to a first port 434, a second tunable portion 432 that includes a cavity 4321 which may be tuned by a PIN diode 4322 and is coupled to a second port 435, and a fixed portion 433 that includes five cavities 4331-4335 and is coupled to a third port 436.

The first port 434 may be externally connected to a matched load 410, e.g. a transmitting module. The second port 435 may be externally connected to another matched load 420, e.g. a receiving module. The third port 436 may be externally connected to a matched load 450, e.g. an antenna unit. It shall be understood that the respective numbers of cavities in both tunable portions and the fixed portion as illustrated in FIG. 4 are exemplary and non-limiting, and other numbers are also possible, depending on practical requirements.

In this embodiment, two PIN diodes 441 and 442 may be interposed respectively between the first port 434 and the load 410 as well as between the second port 435 and the load 420 for providing additional isolation. Usually, the isolation of one PIN diode is less than the isolation of one cavity. Thus, for example, in a case where one cavity cannot provide enough isolation but two cavities are not necessary, a PIN diode may be used instead to contribute additional isolation.

FIG. 4B shows a schematic circuit illustrating operation states of PIN diodes for tuning filter cavities as shown in FIG. 4A. As illustrated in FIG. 4B, when a RF signal is to be transmitted from the third port 436 to the second port 435, for example when a base station using the partly tunable filter 430 is receiving the RF signal via the antenna unit, the PIN diode 4322 operates in the OFF state and the PIN diode 4312 operates in the ON state. At this point, the PIN diode 4312 in the ON state may be equivalently regarded as a small resistor R1 (e.g. about several ohms) and the PIN diode 4322 in the OFF state may be equivalently regarded as a capacitor C connected in parallel with a big resistor R2 (e.g. about several Mega ohms). The resistance exhibited by the equivalent resistor of a PIN diode will have a significant impact on the Q factor of the corresponding cavity tuned by that PIN diode.

As mentioned above, for a filter cavity or a tunable portion working in the pass band, more interests are focused on its Q factor. According to some simulation results, it has been known that the larger reverse resistor of a PIN diode (e.g. the resistor R2 of the PIN diode 4322 in the OFF state) may result in less impact on the Q factor of the cavity tuned by that PIN diode and consequently, have less impact on the insertion loss.

By contrast, for a filter cavity working for rejecting a RF signal, more interests are focused on how much isolation it can provide instead of its Q factor. According to some simulation results, it has been known that the smaller forward resistor of a PIN diode (e.g. the resistor R1 of the PIN diode 4312 in the ON state) may shift the resonant frequency of the cavity tuned by it farther.

Therefore, an appropriate PIN diode can effectively control a filter cavity to either pass a RF signal through or reject the RF signal. Therefore, in a preferred embodiment of the present invention, each of the above first and second tuning circuits may comprise at least one PIN diode. Particularly, the number of the PIN diodes comprised by each of the tuning circuits may be equal to the number of the cavities included in the corresponding tunable portion.

FIG. 5 illustrates an example implementation of the filter 230 of FIG. 2, which is implemented as a partly tunable cavity filter 530. The illustrated filter 530 comprises a plurality of cavities (5311, 5321, 5331-5335). Each of the cavities comprises a metal resonator which may be mechanically tuned before the filter 530 starts operating and then electrically tuned when the filter 530 is in operation.

As illustrated in FIG. 5, on resonators of cavities 5311 and 5321 are respectively connected two tuning circuits 5312, 5322 (i.e. the first and second tuning circuits as described with respect to FIG. 2) for electrically tuning resonant frequencies of corresponding cavities. These tuning circuits are shown as two small PCB boards that may be connected to a control circuit (not shown). It shall be noted that the tuning circuits may be embodied separately from or integrated into the control circuit. Each of the tuning circuits may comprise at least one selected from a group consisting of a PIN diode, varactor diode, MEMS switch or combination of a switch and a capacitor. Preferably, each of the tuning circuits may comprise at least one PIN diode. The number of the PIN diodes comprised in each of the tuning circuits may be equal to the number of the tunable cavities included in the corresponding tunable portion.

The filter 530 further comprises three ports 534, 535 and 536. The cavity 5311 with the tuning circuit 5312 may constitute a first tunable portion 531 coupled to a first port 534. The cavity 5321 with the tuning circuit 5322 may constitute a second tunable portion 532 coupled to a second port 535. The cavities 5331-5335 may constitute a fixed portion 533 coupled to a third port 536 that is terminated with a matched load as illustrated. In practical applications, the first port 534 may be connected to a transmitting module; the second port 535 may be connected to a receiving module; and the third port 536 may be connected to an antenna unit.

When the filter 530 is used for filtering a RF signal to be transmitted from the first port 534 to the third port 536, a control signal from the control circuit may trigger the tuning circuit 5312 to tune the cavity 5311, i.e. the first tunable portion 531, to work in a pass band and meanwhile trigger the tuning circuit 5322 to shift the resonant frequency of the cavity 5321 away from the pass band of the cavity 5311. Thus, the RF signal to be transmitted may flow into the port 534 of the filter 530, then into cavity 5311 and each of the series of cavities 5331-5335 and then out from the port 536 for transmission, e.g. via the antenna unit.

Similarly, when the filter 530 is used for filtering a RF signal to be transmitted from the third port 536 to the second port 535, a control signal from the control circuit may trigger the tuning circuit 5322 to tune the cavity 5321, i.e. the second tunable portion 532, to work in a pass band and meanwhile trigger the tuning circuit 5312 to shift the resonant frequency of the cavity 5311 away from the pass band of the cavity 5321. Thus, the RF signal to be transmitted can flow into the port 536 of the filter 530, then into each of the series of cavities 5331-5335 and cavity 5321 and then out from the port 535, for reception and processing, for example by the receiving module.

The above descriptions of some embodiments of the present invention in connection with FIGS. 1-5 are mainly focused on a TDD communication system. A main objective of the above described embodiments of the present invention is to find a filter and a radio unit to effectively protect the receiver front end of the radio unit from damaging and meanwhile reduce the insertion loss introduced by the filter as low as possible. In the following, descriptions will be given to other embodiments of the present invention to provide another filter and radio unit or base station, which are built based on the previously presented ones, so as to be adapted for a FDD-TDD multimode communication system.

Due to an expected explosive growth of data usage, it has become imperative for operators to make effective use of spectrum and implement advanced technologies as quickly as possible with an ever-increasing number of bands. Therefore, future communication networks may be established compatible with dual technology (FDD and TDD) multiband and multimode capability. With this trend, transceivers with dual technology (FDD and TDD) multiband and multimode capability are already under research and development. RF filters will also be required to have a flexibility to work with RF front-end components from different vendors. In this situation, a newly designed RF filter capable of operating in a FDD-TDD multimode system is desired so as to realize a real FDD-TDD multimode system with a smaller dimension, lower complexity, cost and power consumption. Such an RF filter can provide the scalability and re-usability required to service a large segment of the market.

Reference is now made to FIG. 6, in which a simplified structure of a radio unit 600 for use in a FDD-TDD multimode communication system according to one embodiment of the invention is illustrated.

The illustrated radio unit 600 comprises a transmitting module 610 which may be configured to generate RF signals to be transmitted via an antenna unit 650, a receiving module 620 which may be configured to receive and process the RF signals received via the antenna unit 650, and a filter 630 which is configured for filtering the RF signals to be transmitted or received via the antenna unit 650 so as to filter out unwanted RF components included therein.

The transmitted or received RF signals comprise a first RF signal of a first frequency which may be a TDD downlink signal transmitted from the transmitting module 610, a second RF signal of the first frequency which may be a TDD uplink signal received via the antenna unit 650, a third RF signal of a second frequency which may be a FDD downlink signal transmitted from the transmitting module 610 and a fourth RF signal of a third frequency which may be a FDD uplink signal received via the antenna unit 650. The first frequency may be a frequency within a specified TDD band. The second and third frequencies may be a pair of frequencies used for a FDD uplink and downlink transmission pair within a specified FDD band. Although the aforesaid first RF signal and the second RF signal are of the same frequency, it shall be understood that the first RF signal and the second RF signal may be of different frequencies within a same specified TDD band.

In this embodiment, the filter 630 as illustrated is also implemented as a partly tunable filter and comprises a first filtering part that corresponds to the above described filter 230 and a second filtering part.

The first filtering part comprises a first tunable portion 631 that is connected to the transmitting module 610, a second tunable portion 632 that is connected to the receiving module 620, and a first fixed portion 633 that is connected to the antenna unit 650. The structure of the first filtering part is similar to the filter 230, and thus details of the first filtering part that are the same as the filter 230 will not be described herein for the sake of simplicity. The following will be focused on their differences only.

The second filtering part comprises: a second fixed portion 634 connected to both the transmitting module 610 and the antenna unit 650, which may be used as the transmitting path for FDD downlink transmissions and is configured, for example by mechanically adjusting, to always work in a transmitting band for the third RF signal so as to enable the FDD downlink transmissions at any desired time; and a third fixed portion 635 connected to both the receiving module 620 and the antenna unit 650, which may be used as the receiving path for FDD uplink transmissions and is configured, for example by mechanically adjusting, to always work in a receiving band for the fourth RF signal so as to enable the FDD uplink transmissions at any desired time.

A FDD-TDD multimode communication system supports concurrent FDD and TDD transmissions. That is, there may be a possibility that two (TDD and FDD) downlink signals, i.e. the first and third RF signals are transmitted simultaneously from the transmitting module 610 and meanwhile one FDD uplink signal, i.e. the fourth RF signal is received via the antenna unit 650; or two (TDD and FDD) uplink signals, i.e. the second and fourth RF signals are received simultaneously via the antenna unit 650 and meanwhile one FDD downlink signal, i.e. the third RF signal is transmitted from the transmitting module 610.

Therefore, in different embodiments, the transmitting module 610 may comprise a FDD-TDD multimode transmitter, or comprise both a FDD transmitter and a TDD transmitter so as to conduct FDD and TDD downlink transmissions concurrently. Alternatively or additionally, the receiving module 620 may comprise a FDD-TDD multimode receiver or comprise both a FDD receiver and a TDD receiver so as to conduct FDD and TDD uplink transmissions concurrently.

In this scenario, the newly designed filter shall at least (1) support concurrent FDD and TDD transmissions, (2) be capable of the receiver protection, and (3) reduce the insertion loss as low as possible.

Taking this in consideration, in the embodiment of the present invention, the first tunable portion 631 of the first filtering part in the filter 630 is usually configured to work in a first frequency range that is different from the transmitting band of the second fixed portion 634, such that the third RF signal transmitted from the transmitting module 610, i.e. the FDD downlink transmission, can be rejected by the first tunable portion 631. With this configuration, on the one hand, most or all energy of the third RF signal enters into the second fixed portion 634, and then will be transmitted via the antenna unit 650. On the other hand, the receiving module 620 may be protected by the first tunable portion 631, because if the third RF signal can pass through the first tunable portion 631, it might be reflected by the first fixed portion 633 into the receiving module 620, which may also possibly damage the receiving module 620. Furthermore, the first frequency range in which the first tunable portion 631 is configured to work is further different from a first pass band for the second RF signal in which the second tunable portion 632 is controlled to work when the second RF signal is received via the antenna unit 650, i.e. in a TDD Rx slot, such that the received second RF signal is rejected by the first tunable portion 631 to the transmitting module 610 so as to guarantee most or all of the received RF signal can enter into the second tunable portion 632 and thus be received by the receiving module 620, thereby resulting in less insertion loss.

Additionally, the second tunable portion 632 of the first filtering part of the filter 630 is usually configured to work in a second frequency range different from the receiving band, such that the fourth RF signal received via the antenna unit 650, i.e. the FDD uplink transmission, is rejected by the second tunable portion 632. With this configuration, most or all energy of the fourth RF signal can be received by the receiving module 620 and will not enter into the second tunable portion 632, thereby resulting in less insertion loss. Furthermore, the second frequency range in which the second tunable portion 632 is configured to work is further different from a second pass band for the first RF signal in which the first tunable portion 631 is controlled to work when the first RF signal is to be transmitted from the transmitting module 610, i.e. in a TDD Tx slot, such that the first RF signal to be transmitted can be rejected by the second tunable portion 632 to the receiving module 620 so as to protect the receiving module 620 from damaging by transient high energy possibly reflected from the antenna unit 650.

In a case that the transmitting module 610 comprises a single TDD-FDD multimode transmitting unit, it is preferable that the second pass band of the first tunable portion 621 is not overlapping with the transmitting band of the second fixed portion 634 so that the first RF signal transmitted from the transmitting module 610 will not leak into the second fixed portion 634 and the third RF signal transmitted from the transmitting module 610 will not leak into the first tunable portion 631. Additionally or alternatively, in a case that the receiving module 620 comprises a single TDD-FDD multimode receiving unit, it is preferable that the first pass band of the second tunable portion 622 is not overlapping with the receiving band of the third fixed portion 635 so that the received second RF signal will not leak into the third fixed portion 635 and the received fourth RF signal will not leak into the second tunable portion 632.

Preferably, the first frequency range of the first tunable portion 631 may be non-overlapping with either of the transmitting band of the second fixed portion 634 and the first pass band of the second tunable portion 632. Alternatively or additionally, the second frequency range of the second tunable portion 632 may be non-overlapping with either of the receiving band of the third fixed portion 635 and the second pass band of the first tunable portion 631.

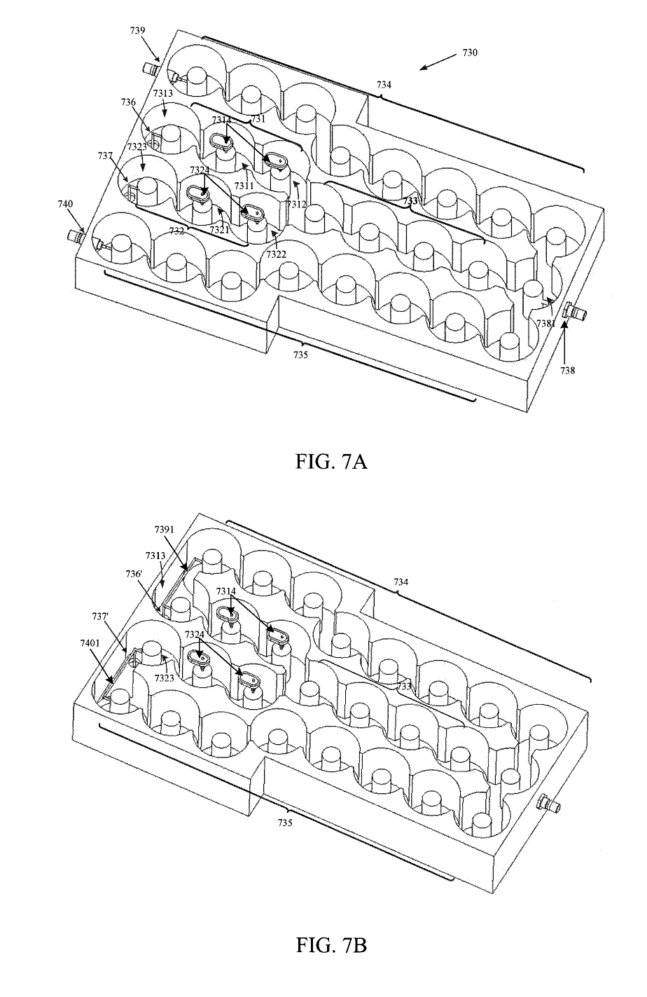

FIG. 7 illustrates an example implementation of the filter 630 of FIG. 6, which is implemented as a partly tunable cavity filter 730. The illustrated filter 730 may comprise a plurality of cavities, which respectively constitute a first tunable portion 731, a second tunable portion 732, a first fixed portion 733, a second fixed portion 734, and a third fixed portion 735 corresponding to those portions as described with respect to FIG. 6. Each of these portions may comprise at least one cavity. Each of the cavities comprises a metal resonator which may be mechanically tuned before the filter 730 starts operating and then electrically tuned when the filter 730 is in operation.

The illustrated filter 730 further comprises five ports 736˜740. The first tunable portion 731 is coupled to a first port 736, and the second tunable portion 732 is coupled to a second port 737. The first fixed portion 733 is coupled to a third port 738. The second fixed portion 734 is coupled to a fourth port 739 and the third port 738 on its both sides, while the third fixed portion 735 is coupled to a fifth port 740 and the third port 738 on its both sides. As illustrated, the third port 738 is shared by the first, second, and third fixed portions, for TDD uplink and downlink transmissions as well as for FDD uplink and downlink transmissions for example.

In the embodiment as illustrated in FIG. 7A, the five ports 736˜740 are configured to be separate, which may correspond to an application scenario that the transmitting module that may be used in connection with the filter 730 comprises a separate TDD transmitter and a separate FDD transmitter, and the receiving module that may be used in connection with the filter 730 comprises a separate TDD receiver and a separate FDD receiver. However, it should be understood that, corresponding to the modes of the transmitting module and the receiving module that may be used in connection with the filter 730, the first port 736 and the fourth port 739 may be combined into a single port and/or the second port 737 and the fifth port 740 may be combined into another single port. For example, in one embodiment as illustrated in FIG. 7B, if the transmitting module that may be used in connection with the filter 730 comprises a FDD-TDD multimode transmitter, then the first and fourth ports 736, 739 may be combined into a single transmitting port 736′. Alternatively or additionally, if the receiving module that may be used in connection with the filter 730 comprises a FDD-TDD multimode receiver, then the second and fifth ports 737, 740 may be combined into a single receiving port 737′. For this reason, a thick and dark line is used in FIG. 6 to connect the output of the transmitting module 610 to an input of the filter 630, which however doesn't mean a one-to-one correspondence between them. Similarly, another thick and dark line connecting the receiving module 620 and the filer 630 doesn't mean a one-to-one correspondence.

Still in the embodiment as illustrated in FIG. 7, the first, second and third fixed portions are coupled to the same third port 738 via a common cavity 7381. However, it shall be understood that, in other embodiments, other known elements for dividing or converging a signal, such as a sheet metal part (e.g. 7391, 7401) as illustrated in FIG. 7B may be used instead of the common cavity 7381. Similarly, the sheet metal part (7391 or 7401) may be replaced with a common cavity.

As illustrated in FIG. 7A, the first tunable portion 731 comprises three cavities 7311˜7313, in which two cavities 7311, 7312 are shown to be tunable. Also, the second tunable portion 732 comprises three cavities 7321˜7323, in which two cavities 7321, 7322 are shown to be tunable. However, in a case where the five ports 736-740 are configured to be separate, all cavities comprised in the first tunable portion 731 or in the second tunable portion 732 are preferably configured to be tunable. That is, the cavity 7313 and the cavity 7323 are also tunable cavities. It shall be understood that the respective numbers of cavities in the tunable portions and the fixed portions as illustrated in FIG. 7 are exemplary and non-limiting, and other numbers are also possible, depending on practical requirements.

By contrast, in a case where the first and fourth ports are combined into the single transmitting port 736′ and/or the second and fifth ports are combined into the receiving port 737′ as illustrated in FIG. 7B, the cavity 7313 is preferably configured to be fixed and/or the cavity 7323 is preferably configured to be fixed due to the fact that when the used FDD band and TDD band are close, the shifting of the resonant frequency of the cavity 7313 may severely deteriorate the performance of the second fixed portion 734 and thus may result in the failure of FDD downlink transmissions; and similarly, the shifting of the resonant frequency of the cavity 7323 may severely deteriorate the performance of the third fixed portion 735 and thus may result in the failure of FDD uplink transmissions. In this case, the first tunable portion 731 may comprise a fixed cavity 7313; and/or the second tunable portion 732 may comprise a fixed cavity 7323, as illustrated in FIG. 7B.

Similarly to the partly tunable filter 530 as described with respect to FIG. 5, on resonators in cavities 7311 and 7312 as shown in FIG. 7A are respectively connected a first tuning circuit 7314 for electrically tuning resonant frequencies of the corresponding cavities. The first tuning circuit 7314 is shown as two small PCB boards that may be connected to a control circuit (not shown) and triggered by a control signal from the control circuit to operate so as to tune the resonant frequencies of the corresponding cavities and accordingly switch the first tunable portion 731 to work in the first frequency range or in the second pass band.

On resonators in cavities 7321 and 7322 as shown in FIG. 7A are also connected a second tuning circuit 7324 for electrically tuning resonant frequencies of the corresponding cavities. The second tuning circuit 7324 is shown as two small PCB boards that may be connected to the control circuit (not shown) and triggered by the control signal from the control circuit to operate so as to tune the resonant frequencies of the corresponding cavities, and accordingly switch the second tunable portion 732 to work in the second frequency range or in the first pass band.

It shall be understood that the first and second tuning circuits may be embodied separately from the control circuit or integrated into the control circuit. Each of the tuning circuits may comprise at least one selected from a group consisting of a PIN diode, varactor diode, MEMS switch or combination of a switch and a capacitor. Preferably, each of the first and second tuning circuits may comprise at least one PIN diode. Particularly, the number of the PIN diodes comprised in each of the tuning circuits may be equal to the number of the tunable cavities included in the corresponding tunable portion.

In use of the filter 730 as illustrated in FIG. 7B in a FDD-TDD communication system, when the aforesaid first RF signal is to be transmitted from the transmitting port 736′ to the third port 738, the aforesaid third RF signal is to be transmitted from the transmitting port 736′ to the third port 738 while the aforesaid fourth

RF signal is to be transmitted from the third port 738 to the receiving port 737′, a control signal from the control circuit may trigger the tuning circuits 7314 and 7324 to shift the resonant frequencies of the corresponding cavities so that the first tunable portion 731 is tuned to work in the second pass band that is non-overlapping with the transmitting band of the second fixed portion 734 and the second tunable portion 732 is tuned to work in the second frequency range different from both the receiving band of the third fixed portion 735 and the second pass band in which the first tunable portion 731 is tuned to work, such that not only the first RF signal can be rejected by the second tunable portion 732 to the receiving port 737′ but also the above fourth RF signal received simultaneously from the third port 738 can also be rejected by the second tunable portion 732. In this case, the first RF signal may flow into the transmitting port 736′ of the filter 730 and then into the first tunable portion 731, the first fixed portion 733 and then out from the third port 738 for transmission, for example, via the externally connected antenna unit. In the meantime, the third RF signal may flow into the transmitting port 736′ of the filter 730, then into the second fixed portion 734 and then out from the third port 738 of the filter 730 for transmission, and the fourth RF signal may flow into the third port 738, then into the third fixed portion 735 and then out from the receiving port 737′ for reception and processing, for example, by the externally connected receiving module.

In contrast, when the aforesaid second RF signal is to be transmitted from the third port 738 to the receiving port 737′, the aforesaid third RF signal is to be transmitted from the transmitting port 736′ to the third port 738 while the aforesaid fourth RF signal is to be transmitted from third port 738 to the receiving port 737′, a control signal from the control circuit may trigger the tuning circuits 7314 and 7324 to shift the resonant frequencies of the corresponding cavities so that the second tunable portion 732 is tuned to work in the first pass band that is non-overlapping with the receiving band of the third fixed portion 735, and the first tunable portion 731 is tuned to work in the first frequency range different from both the transmitting band of the second fixed portion 734 and the first pass band in which the second tunable portion 732 is tuned to work, such that not only the second RF signal can be rejected by the first tunable portion 731 to the transmitting port 736′ but also the above third RF signal received simultaneously from the transmitting port 736′ can also be rejected by the first tunable portion 731. In this case, the second RF signal may flow into the third port 738 of the filter 730 and then into the first fixed portion 733, the second tunable portion 732 and then out from the receiving port 737′ for reception and processing, for example, by the externally connected receiving module. In the meantime, the fourth RF signal may flow into the third port 738 of the filter 730, then into the third fixed portion 735 and then out from the receiving port 737′ of the filter 730, and the third RF signal may flow into the transmitting port 736′, then into the second fixed portion 734 and then out from the third port 738 for transmission, for example, via the externally connected antenna unit.

It shall be understood that although the above described filter and radio unit are configured for a FDD-TDD multimode communication system, they may also be used for other communication systems by adapting the modes of the transmitting module and the receiving module and their connection relationship with the filter. For example, the above described filter 630 or 730 may also be used for a FDD or TDD communication system in connection with a single FDD or TDD transmitter and a single FDD or TDD receiver.

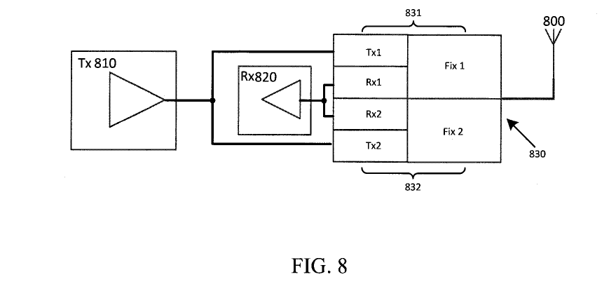

FIG. 8 illustrates a partly tunable filter 830 for use in a TDD dual band communication system. The illustrated filter 830 may comprise a first partly tunable filter 831 and a second partly tunable filter 832. Each of the first and second partly tunable filters 831, 832 has the similar structure as the first filtering part of the filter 730, that is, each of portions Tx1, Tx2, Rx1 and Tx2 as illustrated is tunable and each of portions Fix1 and Fix 2 is fixed. For the sake of simplicity, the detailed description of each portion is omitted herein. The portions Tx1, Tx2 may be connected altogether to a transmitting module 810 and the portions Rx1, Rx2 may be connected altogether to a receiving module 820. With this configuration, for example, a RF signal in a first TDD band may be communicated via the first partly tunable filter 831 while another RF signal in a different second TDD band may be communicated via the second partly tunable filter 832, so that TDD dual band communications can be realized by using the filter 830.

While the invention has been described in terms of several embodiments, those skilled in the art will recognize that the invention is not limited to the embodiments described, and can be practiced with modification and alteration within the disclosure and scope of the appended claims. The description is thus to be regarded as illustrative instead of limiting.

1. A radio unit for use in a time division duplex communication system, comprising:
a transmitting module;
a receiving module; and
a filter for filtering a radio frequency signal to be transmitted or received via an antenna unit, comprising:
a first tunable portion connected to the transmitting module,
a second tunable portion connected to the receiving module, and
a fixed portion connected to the antenna unit,
wherein each of the first tunable portion and the second tunable portion is configured to connect to the antenna unit via the fixed portion;
wherein the first tunable portion is further configured to work in a first frequency range different from a first pass band in which the second tunable portion is controlled to work when the radio frequency signal is received via the antenna unit, such that the received radio frequency signal is rejected by the first tunable portion to the transmitting module; and the second tunable portion is further configured to work in a second frequency range different from a second pass band in which the first tunable portion is controlled to work when the radio frequency signal from the transmitting module is to be transmitted via the antenna unit, such that the radio frequency signal to be transmitted is rejected by the second tunable portion to the receiving module.

2. The radio unit according to claim 1, wherein
the filter comprises a plurality of cavities; and
each of the first tunable portion, the second tunable portion and the fixed portion comprises at least one cavity.

3. The radio unit according to claim 1, wherein
the first tunable portion and the second tunable portion are configured to be tuned separately by a first tuning circuit and a second tuning circuit that are triggered by a control signal.

4. The radio unit according to claim 3, wherein each of the first tuning circuit and the second tuning circuit comprises at least one PIN diode.

5. The radio unit according to claim 1, wherein the transmitting module further comprises an isolator capable of absorbing energy reflected from the antenna unit when the radio frequency signal is transmitted.

6. The radio unit according to claim 5, wherein
the isolator comprises a circulator.

7. The radio unit according to claim 1, wherein the first frequency range is non-overlapping with the first pass band; or
the second frequency range is non-overlapping with the second pass band; or
the first frequency range is non-overlapping with the first pass band and the second frequency range is non-overlapping with the second pass band.

8. (canceled)

9. A partly tunable filter for filtering a radio frequency signal, comprising:
a first tunable portion coupled to a first port;
a second tunable portion coupled to a second port; and
a fixed portion coupled to a third port,
wherein each of the first tunable portion and the second tunable portion is configured to couple to the third port via the fixed portion;
wherein the first tunable portion is further configured to work in a first frequency range different from a first pass band in which the second tunable portion is controlled to work when the radio frequency signal is to be transmitted from the third port to the second port, such that the radio frequency signal is rejected by the first tunable portion to the first port; and the second tunable portion is further configured to work in a second frequency range different from a second pass band in which the first tunable portion is controlled to work when the radio frequency signal is to be transmitted from the first port to the third port, such that the radio frequency signal is rejected by the second tunable portion to the second port.

10. The partly tunable filter according to claim 9, comprising a plurality of cavities, wherein
each of the first tunable portion, the second tunable portion and the fixed portion comprises at least one cavity.

11. The partly tunable filter according to claim 9, wherein
the first tunable portion and the second tunable portion are configured to be tuned separately by a first tuning circuit and a second tuning circuit that are triggered by a control signal.

12. The partly tunable filter according to claim 11, wherein
each of the first tuning circuit and the second tuning circuit comprises at least one PIN diode.

13. The partly tunable partly tunable filter according to claim 9, wherein
the first frequency range is non-overlapping with the first pass band; or
the second frequency range is non-overlapping with the second pass band; or
the first frequency range is non-overlapping with the first pass band and the second frequency range is non-overlapping with the second pass band.

14. The partly tunable filter according to claim 9, wherein the partly tunable filter is configured to connect to a transmitting module via the first port, and to connect to a receiving module via the second port.

15. The partly tunable filter according to claim 9, wherein the partly tunable filter is configured to connect to an antenna unit via the third port.

16. (canceled)

17. A radio unit for use in a multimode communication system, comprising:
a transmitting module;
a receiving module; and
a filter for filtering radio frequency signals to be transmitted or received via an antenna unit, wherein the radio frequency signals comprise a first radio frequency signal of a first frequency, a second radio frequency signal of the first frequency, a third radio frequency signal of a second frequency and a fourth radio frequency signal of a third frequency, the filter comprising:
a first filtering part that comprises:
a first tunable portion connected to the transmitting module,
a second tunable portion connected to the receiving module, and
a first fixed portion connected to the antenna unit,
wherein each of the first tunable portion and the second tunable portion is configured to connect to the antenna unit via the first fixed portion; and
a second filtering part that comprises:
a second fixed portion connected to the transmitting module and the antenna unit, and working in a transmitting band for the third radio frequency signal; and
a third fixed portion connected to the receiving module and the antenna unit, and working in a receiving band for the fourth radio frequency signal;
wherein the first tunable portion is further configured to work in a first frequency range different from the transmitting band, such that the third radio frequency signal from the transmitting module is rejected by the first tunable portion, and wherein the first frequency range is further different from a first pass band for the second radio frequency signal in which the second tunable portion is controlled to work when the second radio frequency signal is received via the antenna unit, such that the received second radio frequency signal is rejected by the first tunable portion to the transmitting module; and
the second tunable portion is further configured to work in a second frequency range different from the receiving band, such that the fourth radio frequency signal received via the antenna unit is rejected by the second tunable portion, and wherein the second frequency range is further different from a second pass band for the first radio frequency signal in which the first tunable portion is controlled to work when the first radio frequency signal is to be transmitted from the transmitting module via the antenna unit, such that the first radio frequency signal to be transmitted is rejected by the second tunable portion to the receiving module.

18. The radio unit according to claim 17, wherein
the transmitting module comprises a multimode transmitter; and
the second pass band is non-overlapping with the transmitting band.

19. The radio unit according to claim 17, wherein
the transmitting module further comprises an isolator capable of absorbing energy reflected from the antenna unit when the first or third radio frequency signal is transmitted.

20. The radio unit according to claim 17, wherein
the receiving module comprises a multimode receiver; and
the first pass band is non-overlapping with the receiving band.

21. The radio unit according to claim 16, wherein
the filter comprises a plurality of cavities; and
each of the first tunable portion, the second tunable portion and the first, second and third fixed portions comprises at least one cavity.

22. The radio unit according to claim 17, wherein
the first tunable portion and the second tunable portion are tuned separately by a first tuning circuit and a second tuning circuit that are triggered by a control signal.

23. The radio unit according to claim 22, wherein each of the first tuning circuit and the second tuning circuit comprises at least one PIN diode.

24. The radio unit according to claim 17, wherein
the first frequency range is non-overlapping with the first pass band; or
the second frequency range is non-overlapping with the second pass band; or
the first frequency range is non-overlapping with the first pass band and the second frequency range is non-overlapping with the second pass band.

25. (canceled)

26. A partly tunable filter for filtering radio frequency signals that comprises a first radio frequency signal of a first frequency, a second radio frequency signal of the first frequency, a third radio frequency signal of a second frequency and a fourth radio frequency signal of a third frequency, comprising:
a first filtering part that comprises:
a first tunable portion coupled to a first port;
a second tunable portion coupled to a second port; and
a first fixed portion coupled to a third port,
wherein each of the first tunable portion and the second tunable portion is configured to couple to the third port via the first fixed portion; and
a second filtering part that comprises:
a second fixed portion coupled to the third port and a fourth port and working in a transmitting band for the third radio frequency signal; and
a third fixed portion coupled to the third port and a fifth port and working in a receiving band for the fourth radio frequency signal;
wherein the first tunable portion is configured to work in a first frequency range different from the transmitting band, such that the third radio frequency signal from the fourth port is rejected by the first tunable portion, and the first frequency range is further different from a first pass band for the second radio frequency signal in which the second tunable portion is controlled to work when the second radio frequency signal is to be transmitted from the third port to the second port, such that the second radio frequency signal is rejected by the first tunable portion to the first port; and
wherein the second tunable portion is configured to work in a second frequency range different from the receiving band, such that the fourth radio frequency signal from the third port is rejected by the second tunable portion, and the second frequency range is further different from a second pass band for the first radio frequency signal in which the first tunable portion is controlled to work when the first radio frequency signal is to be transmitted from the first port to the third port, such that the first radio frequency signal is rejected by the second tunable portion to the second port.

27. The partly tunable filter according to of claim 26, comprising a plurality of cavities, wherein
each of the first tunable portion, the second tunable portion and the first, second and third fixed portions comprises at least one cavity.

28. The partly tunable filter according to claim 26, wherein
the first port and the fourth port are combined into a single transmitting port; and
the second pass band is non-overlapping with the transmitting band.

29. The partly tunable filter according to claim 28, wherein
the first tunable portion comprises at least one fixed cavity coupled to the single transmitting port.

30. The partly tunable filter according to claim 26, wherein
the second port and the fifth port are combined into a single receiving port; and
the first pass band is non-overlapping with the receiving band.

31. The partly tunable filter according to claim 30, wherein the second tunable portion comprises at least one fixed cavity coupled to the single receiving port.

32. The partly tunable filter according to claim 26, wherein
the first tunable portion and the second tunable portion are tuned separately by a first tuning circuit and a second tuning circuit that are triggered by a control signal.

33. The partly tunable filter according to claim 32, wherein each of the first tuning circuit and the second tuning circuit comprises at least one PIN diode.

34. The partly tunable filter according to claim 26, wherein
the first frequency range is non-overlapping with the first pass band; or
the second frequency range is non-overlapping with the second pass band; or
the first frequency range is non-overlapping with the first pass band and the second frequency range is non-overlapping with the second pass band.

35. (canceled)
